(19) United States
(12) Patent Application Publication
(10) Pub. No.: US 2016/0099853 A1
(43) Pub. Date: Apr. 7, 2016

(54) ACTIVE AND PASSIVE DATAPLANE PERFORMANCE MONITORING OF SERVICE FUNCTION CHAINING

(71) Applicant: CISCO TECHNOLOGY, INC., San Jose, CA (US)

(72) Inventors: Plamen Nedeltchev Nedeltchev, San Jose, CA (US); Aamer Saeed Akhter, Cary, NC (US); Carlos M. Pignataro, Raleigh, NC (US)

(73) Assignee: CISCO TECHNOLOGY, INC., San Jose, CA (US)

(21) Appl. No.: 14/504,076

(22) Filed: Oct. 1, 2014

(51) Int. Cl. H04L 12/26; H04L 29/08; H04L 29/06

(52) U.S. Cl. CPC H04L 43/0852; H04L 69/22; H04L 69/324; H04L 43/0888

(57) ABSTRACT

The present disclosure describes a technique for performing performance monitoring of service chains. Variations on performance monitoring can include: passive monitoring, active monitoring, or hybrid monitoring. To provide performance monitoring, the Network Service Header (NSH) is modified to include telemetry information usable for monitoring the performance of a particular traffic flow being transported over a service path.

### TECHNICAL FIELD

This disclosure relates in general to the field of communications and, more particularly, to active and passive dataplane performance monitoring of service function chaining.

### BACKGROUND

In computer networking, network administrators are often concerned with how to best route traffic flows from one end point to another end point across a network. When provisioning a route for a traffic flow, administrators may implement policies to ensure that certain service functions are applied to the packet or the traffic flow as it traverses across the network. Service functions can provide security, wide area network (WAN) acceleration, and loadbalancing. These service functions can be implemented at various points in the network infrastructure, such as the wide area network, data center, campus, etc. Network elements providing these service functions are generally referred to as “service nodes.”

Traditionally, service node deployment is dictated by the network topology. For instance, firewalls are usually deployed at the edge of an administrative zone for filtering traffic leaving or entering the particular zone according to a policy for that zone. With the rise of virtual platforms and more agile networks, service node deployment can no longer be bound by the network topology. To enable service nodes to be deployed anywhere on a network, a solution called Service Function Chaining Architecture (IETF draft-quinn-sfc-arch-05, May 5, 2014) and Network Service Header (IETF draft-quinn-sfc-nsh-02, Feb. 14, 2014) have been provided to encapsulated packets or frames to prescribe service paths for traffic flows through the appropriate service nodes. Specifically, Network Service Headers provide data plane encapsulation that utilizes the network overlay topology used to deliver packets to the requisite services.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIGS. 1A-B illustrate different service paths realized using network service chaining;

FIG. 2 shows a system view of a Service Chain Function-aware network element for prescribing a service path of a traffic flow, according to some embodiments of the disclosure;

FIG. 3 shows a system view of a service node, according to some embodiments of the disclosure;

FIG. 4 shows a flow diagram illustrating a method for monitoring performance of a service path, according to some embodiments of the disclosure;

FIG. 5 shows an exemplary service header having a flag for indicating whether the service header includes one or more fields carrying dataplane performance monitoring information, according to some embodiments of the disclosure;

FIG. 6 shows an exemplary service header set to carry one or more fields carrying dataplane performance monitoring information and a set of exemplary fields, according to some embodiments of the disclosure;

FIG. 7 shows an exemplary service header employing two flags, according to some embodiments of the disclosure; and

FIGS. 8-9 show two examples of the service header having the two flags set to indicate whether the network service header has fields carrying dataplane performance monitoring information and a type of traffic flow, according to some embodiments of the disclosure.

### DETAILED DESCRIPTION OF EXAMPLE EMBODIMENTS

### Overview

The present disclosure describes a technique for performing performance monitoring of service chains. Variations on performance monitoring can include: passive monitoring, active monitoring, or hybrid monitoring. To provide performance monitoring, the Network Service Header (NSH) is modified to include telemetry information usable for monitoring the performance of a particular traffic flow being transported over a service path.

In some embodiments, a method is provided for monitoring performance of a service path identified by a service path identifier. The service path connects a first end point and a second end point via one or more service nodes. The first service node receives, at a first service node, a packet of a flow being transported over the service path. The first service node processes a network service header of the packet, wherein the network service header comprises the service path identifier and one or more of the following: (1) sequence number, (2) a first timestamp information, and (3) flow identifier associated with the flow being transported over the service path. Besides such method, corresponding apparatus and computer-readable medium embodiments are also disclosed herein.

Advantageously, the information in the network service header enables the first service node or some other suitable monitoring node to determine one or more network performance characteristics of the flow based on any one or more of (1), (2), and (3). The one or more network performance characteristics includes one or more of the following: packet count, packet delay, jitter, packet loss, network latency, reordered packet count, duplicate packet count, service throughput, and inter-service node latency, etc.

There are several variations on the timestamp information being carried in the network service header. In one example, the first timestamp information comprises a timestamp associated with a time at which a beginning service node or a proxy of the beginning service node in the service path processes the packet. Advantageously, the latency between the first service node and the beginning service node can be measured from this first timestamp information. In another example, the first service node adds a second timestamp information to the network service header prior to forwarding the packet to a second service node in the service path, wherein the second timestamp information is associated with a time at which the first service node processes the packet. Advantageously, inter-hop latency can be measured between service nodes.

Besides providing telemetry information, the network service header can be configured to carry telemetry information in an active monitoring mode or a passive monitoring mode. Over the life of a flow, active and/or passive monitoring modes can be used to advantageously provide consistent telemetry measurements. In some embodiments, the network service header further comprises a first flag for indicating that the network service header carries one or more of (1) to (3). In some embodiments, the network service header further comprises a second flag for indicating the packet is part of a synthetic traffic flow or a user traffic flow.

In some cases, a monitoring node may collect telemetry information from the service nodes receiving such an improved network service header. One example includes collecting a list of timestamps as the packet is processed by the different service nodes. For these cases, the first service node can transmit a third timestamp information to the monitoring node (in response to receiving the network service header indicating a request for such timestamp information). The third timestamp information can associated with a time at which the first service node processes the packet, and the third timestamp information is usable by the monitoring node in compiling a list of timestamps associated with times at which a plurality of service nodes of the service path processes the packet.

### Example Embodiments

Basics of Network Service Chaining or Service Function Chains in a Network

To accommodate agile networking and flexible provisioning of network nodes in the network, Service Function Chains (SFC) can be used to ensure an ordered set of Service Functions (SF) to be applied to packets and/or frames of a traffic flow. Furthermore, SFCs describe a method for deploying SFs in a way that enables dynamic ordering and topological independence of those SFs. An SFC defines an ordered set of service functions that must be applied to packets and/or frames selected as a result of classification. The implied order may not be a linear progression as the architecture allows for nodes that copy to more than one branch. The term service chain is often used as shorthand for service function chain. A Service Node (SN) can be a physical or virtual element that hosts one or more service functions (SFs) and has one or more network locators associated with it for reachability and service delivery. Service Function Path (SFP) (or sometimes referred simply as service path) relates to the instantiation of a SFC in the network. Packets follow a service path from a classifier through the requisite service functions.

Used herein, an SF is a function that is responsible for specific treatment of received packets. An SF can act at the network layer or other OSI layers. An SF can be a virtual instance or be embedded in a physical network element such as a service node. One of multiple SFs can be embedded in the same network element or service node. Multiple instances of the SF can be enabled in the same administrative domain. A non-exhaustive list of SFs includes: firewalls, WAN and application acceleration, Deep Packet Inspection (DPI), server load balancers, NAT44, NAT64, HOST_ID injection, HTTP Header Enrichment functions, TCP optimizer, etc. An SF may be SFC encapsulation aware, that is it receives, and acts on information in the SFC encapsulation, or unaware in which case data forwarded to the service does not contain the SFC encapsulation.

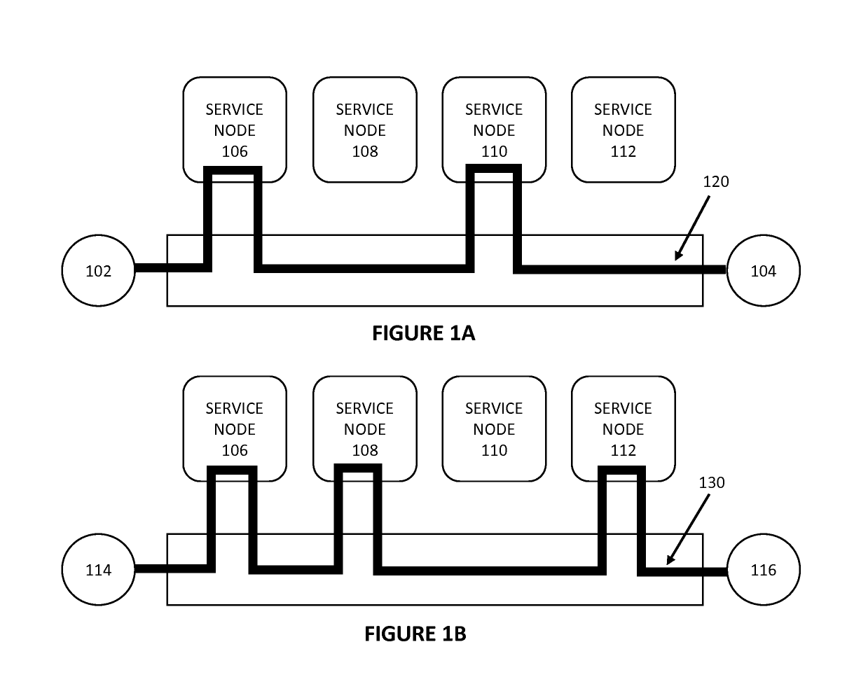

FIGS. 1A-B illustrate different service paths realized using network service chaining. These service paths can be implemented by encapsulating packets of a traffic flow with a network service header (NSH) or some other suitable packet header which specifies a desired service path. In the example shown in FIG. 1A, a service path 120 can be provided between end point 104 through service node 106 and service node 110. In the example shown in FIG. 1B, a service path 130 can be provided between end point 114 through service node 106, service node 108, and service node 112.

Network Service Header Encapsulation

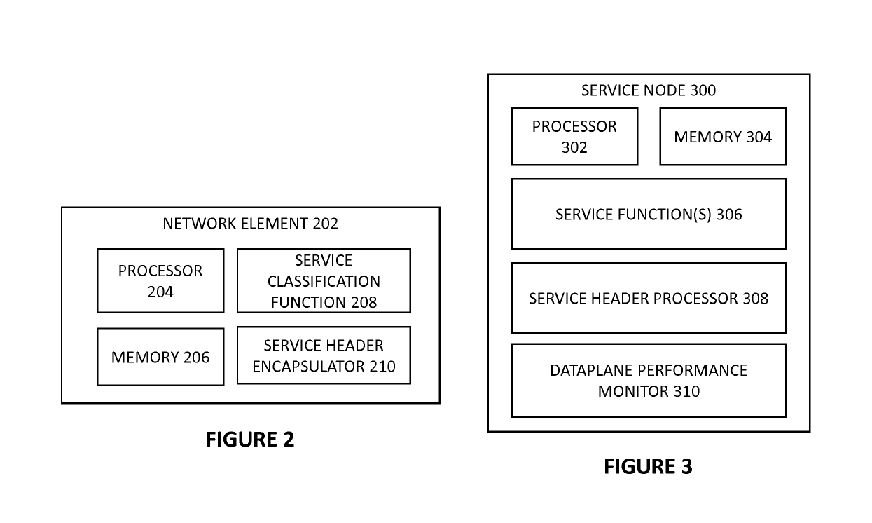

Generally speaking, an NSH includes service path information, and NSH is added to a packet or frame. The packets and NSH are encapsulated in an outer header for transport. To implement a service path, a network element such as a classifier or some other suitable SFC-aware network element can process packets of a traffic flow and performs NSH encapsulation according to a desired policy for the traffic flow. FIG. 2 shows a system view of SFC-aware network element for prescribing a service path of a traffic flow, according to some embodiments of the disclosure. Network element 202 includes processor 204, (computer-readable non-transitory) memory 206 for storing data and instructions. Furthermore, network element 202 includes service classification function 208 and service header encapsulator 210 (both can be provided by processor 204 when processor 204 executes the instructions stored in memory 206).

The service classification function 208 can process a packet of a traffic flow and determine whether the packet requires servicing and correspondingly which service path to follow to apply the appropriate service. The determination can be performed based on business policies and/or rules stored in memory 206. Once the determination of the service path is made, service header encapsulator 210 generates an appropriate NSH having identification information for the service path and adds the NSH to the packet. The service header encapsulator 210 further provides an outer encapsulation to forward the packet to the start of the service path. Other SFC-aware network elements are thus able to process the NSH while other non-SFC-aware network elements would simply forward the encapsulated packets as is.

Similar to inserting NSH, network element 202 can also remove the NSH if the service classification function 208 determines the packet does not require servicing.

Network Service Headers

A network service header can include a (e.g., 64-bit) base header, and one or more context headers. Generally speaking, the base header provides information about the service header and service path identification (e.g., a service path identifier), and context headers can carry opaque metadata. Based on the information in the base header, a service function can derive policy selection from the NSH. For instance, context headers shared in the NSH can provide a range of service-relevant information such as traffic classification. Service functions can use NSH to select local service policy.

Service Nodes and Proxy Nodes

Once properly encapsulated, the packet now having the NSF is then forwarded to service nodes where service(s) can be applied to the packet. FIG. 3 shows a system view of a service node, according to some embodiments of the disclosure. Service node 300, generally a network element, can include processor 302, (computer-readable non-transitory) memory 304 for storing data and instructions. Furthermore, service node 300 includes service function(s) 306 (e.g., for applying service(s) to the packet) and service header processor 308. The service functions(s) 306 and service header processor 306 can be provided by processor 302 when processor 302 executes the instructions stored in memory 304.

Service header processor 308 can extract the NSF header, and in some cases, update the service header as needed. For instance, the service header processor 308 can decrement the service index if a service index=0 is used to indicate that a packet is to be dropped by the service node 300. In another instance, the service header processor 308 can update context headers if new/updated context is available.

Shortcomings of SFC: Lack of Telemetry

SFC has been an effective model for implementing service paths in dynamic virtualized or cloud-based data centers. SFC provides the ability to share information between the network and services and among services. Service chains span and converge virtual and physical loads and hybrid environments. Furthermore, the model can provide a forwarding-plane abstraction and a programmable framework for inserting or removing service functions such as firewalls, load balancers, and WAN optimization at the hypervisor layer. The existing NSH solution is providing a service overlay for virtualized or cloud-based data centers and the following benefits:
Ability to span virtualized computing resources in public, private, or hybrid cloud environments, with zone and edge security,
Ability to enforce policies based on full contextual understanding of security and VM contexts,
A robust platform that provides seamless integration with different virtual services and supports data acceleration by offloading policy from service nodes, and
Single management interface for intra-tenant and tenant-edge security services.

However, SFC does not provide techniques for collecting telemetry information or collect performance or service level agreement (SLA) based service delivery. Some possible candidates for a transport protocol (e.g., Virtual eXtensible Local Area Network (VxLAN), Network Virtualization using Generic Routing Encapsulation (NVGRE), Multiprotocol Label Switching (MPLS)) generally do not provide native provisions for allowing telemetry information to be collected either. Considering that security, performance, as well as cost, are the main considerations when it comes to enterprises moving services to cloud based solutions, these set of capabilities could benefit enterprises and other customers to evaluate the SLA of services received.

Augmenting Network Service Header to Carry Telemetry Information

A solution to the issue described above can involve embedding information in the NSH of the data forwarding path to enable dataplane performance monitoring of service chains. Telemetry as used herein relates to a technique by which information about the performance of a network, a service path, or hops between service nodes, is recorded and collected at various service nodes in the service path (or at some other suitable network element or monitoring node for providing performance monitoring).

A telemetry solution can advantageously use the SFC service overlays in conjunction with performance measurement tools and facilities. Furthermore, the solution can advantageously enable the virtualized or cloud services to be associated with SLA/assurance and performance as well as proactive troubleshooting capabilities. Equipped with telemetry information, cloud service providers can effectively establish problem detection and isolation techniques with service chaining. Referring back to FIG. 3, service node 300 can further include dataplane performance monitor 310 for determining and/or recording telemetry information. Furthermore, dataplane performance monitor 310 can be provided to determine network performance characteristics. Dataplane performance monitor 310 can be provided by processor 302 when processor 302 executes the instructions stored in memory 304. Used herein, telemetry information includes any suitable information for determining network performance characteristics associated with a service path, individual traffic flows using the service path, and in some cases the individual packets therein.

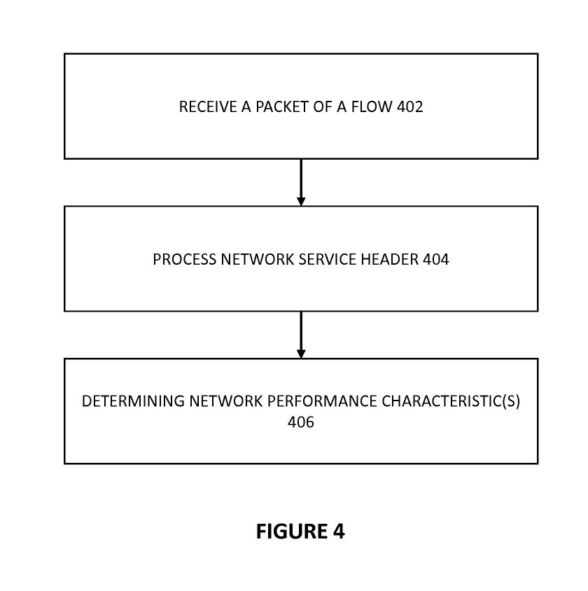

FIG. 4 shows a flow diagram illustrating a method for monitoring performance of a service path identified by a service path identifier, according to some embodiments of the disclosure. The method can be implemented at least in part by service header processor 308 and dataplane performance monitor 310 of FIG. 3 or by some other suitable module on a network element. Generally speaking, the service path connects a first end point and a second end point via one or more service nodes (e.g., as seen in FIGS. 1A-B). A first service node receives a packet of a flow being transported over the service path (box 402). Then, the first service node processes a network service header of the packet (box 404). These two parts of the method shown can be performed by the service header process 308 of FIG. 3.

Augmented with telemetry information, the network service header can include the service path identifier and one or more of the following: (1) sequence number, (2) a first timestamp information (e.g., Network Time Protocol (NTP) timestamp), and (3) flow identifier (e.g., service flow identifier (SFID)) associated with the flow being transported on the service path. It is understood that other suitable telemetry information can be included in the network service header as type-length-values (TLVs), e.g., further sequence number(s), further timestamps, and synchronization source identifier (SSRC). In some instances, processing the network service header of the packet comprises storing information from the network service header in a memory (for collecting the telemetry data, or for saving to allow for later processing).

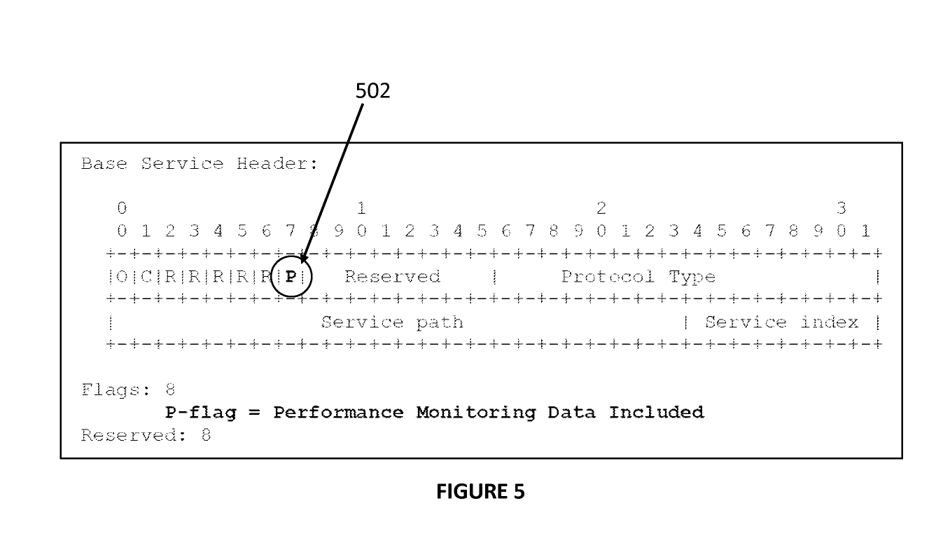

By having the improved network service header, the telemetry information piggybacked with the service path information can enable network performance characteristics to be determined or calculated, e.g., by dataplane performance monitor 310 of FIG. 3. For instance, the first service node and/or some other suitable network element can determine one or more network performance characteristics of the flow based on any one or more of (1), (2), (3) (box 406) (or any other suitable telemetry information). These pieces of information and other pieces of information in the network service header are described in detail in relation to FIGS. 5-9.

Generally speaking, the network performance characteristics can be determined based on any (pieces of) information provided in the network service header. The network performance characteristics can include: packet count, packet delay, jitter, packet loss, network latency, reordered packet count, duplicate packet count, service throughput, media specifics (interfaces), and inter-service node latency. In combination with context headers, context and telemetry information for every service path and individual traffic flows therein can be used for troubleshooting, monitoring, and SLA-based service delivery.

Improved Network Service Header

The NSH generally includes metadata and service path information that is added to a packet or frame and used to create a service plane. The packets and the NSH are then encapsulated in an outer header for transport between pairs of service nodes, creating a service hop. In one exemplary implementation of an NSH, the NSH is composed of a 64-bit base header, and four 32-bit headers. While the present disclosure uses NSH as an example, it is understood by one skilled in the art that other suitable headers for prescribing a service path and corresponding service node(s) in service function chaining can also be used to carry telemetry information.

The NSH base header provides information about the service header and service path identification; and context headers carry opaque metadata. The improved NSH, as described in relation to FIG. 4, can carry one or more additional pieces of information for telemetry purposes: (1) a sequence number, (2) a first timestamp information (e.g., Network Time Protocol (NTP) timestamp), and (3) flow identifier associated with the flow (e.g., service flow identifier (SFID)). The result is that the underlying hops (e.g., service nodes properly equipped with, e.g., dataplane performance monitor 310 of FIG. 3) can examine not only the service chain information, but also telemetry information such as (1) through (3) being carried in the NSH. As a result, these underlying hops and any suitable monitoring node can evaluate the quality of the services provided or service performance using the improved NSH.

FIG. 5 shows an exemplary service header having a flag for indicating whether the service header includes one or more fields carrying dataplane performance monitoring information, according to some embodiments of the disclosure. In some embodiments, a first flag 502 (or a bit) in the base header (shown as “P”, sometimes referred herein as the “P-flag”) is provided (when set to a first state) to indicate the presence of telemetry information in the header (e.g., Performance Management (PM) monitoring data). In other words, the first flag 502 indicates that the NSH carries one or more of (1) to (3) (and/or any suitable telemetry information or data for dataplane performance monitoring). When the first flag 502 is cleared (set to a second state), the NSH does not carry any telemetry information.

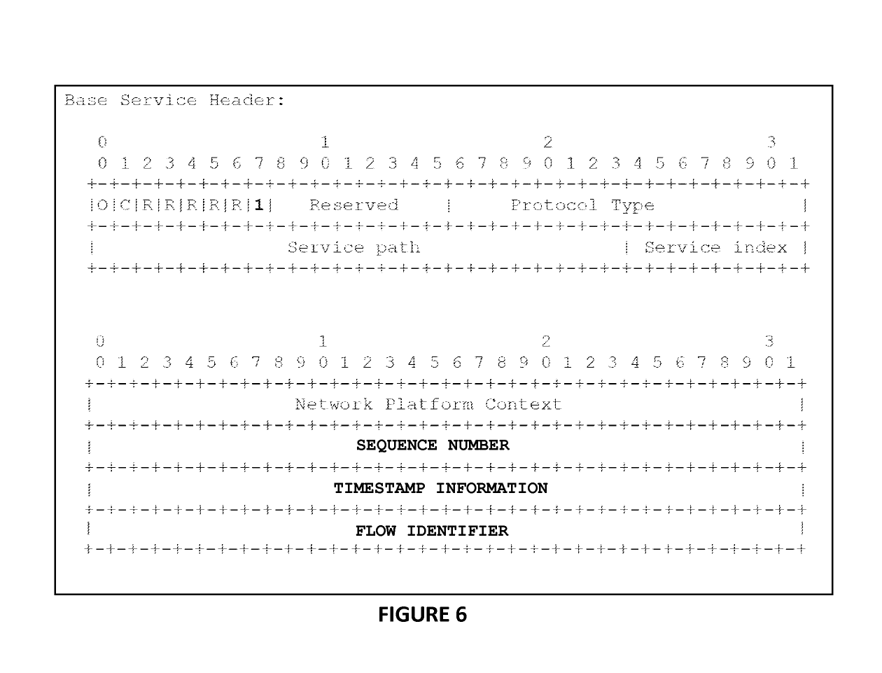

FIG. 6 shows an exemplary service header set to carry one or more fields carrying dataplane performance monitoring information and a set of exemplary fields, according to some embodiments of the disclosure. In this example, the first flag 502 is set to the first state (e.g., 1) and the base header carries, besides information for the network platform context, (1) sequence number, (2) a timestamp information (e.g., Network Time Protocol (NTP) timestamp), and (3) flow identifier associated with the flow (e.g., service flow identifier (SFID)). Broadly speaking, any suitable combination of telemetry information (e.g., any one or more of (1), (2) or (3)) can be provided in the base header.

Sequence Number

One of the telemetry information carried in the NSH is a sequence number associated with the particular packet. For a sequence of packets, the sequence numbers for these packets increase over the sequence of packets in the flow. In the example shown in FIG. 6, the sequence number is carried in a 32-bit field. Generally speaking, the sequence number is incremented by one for each NSH packet. The presence of sequence numbers makes it possible to determine many performance characteristics. For instance, the sequence number can be used to determine whether a packet has been lost or how many packets were lost. In another instance, the sequence number can be used to determine whether the packets arrived out of order. In many instances, sequence numbers can be used for assessing jitter in the network.

In some embodiments, the highest order bit of the sequence number field can represent the scope of the service chain span. For instance, a value of 0 for the highest order bit can represent the whole chain, while a value of 1 for the highest order bit can represent the service node to service node span. While in most cases it is helpful to have the whole upstream path represented, there are cases where a service node might alter the packet count legitimately (e.g., due to compression, firewall, service node proxy function, etc.) and this condition is not a case for loss. In these cases, when a high order bit is set to 1 (or any suitable state, depending on the application), the each previous service node can be responsible for monotonically increasing the packet sequence number.

Timestamps or Timestamp Information

Generally speaking, timestamp information can be very useful for telemetry because timestamps can be used for determining many network performance characteristics related to timing, e.g., delay, latency, throughput, etc. In some embodiments, timestamp information comprises a representation of time in Network Time Protocol (NTP) format down to the nanosecond resolution. Different timestamp information can be recorded at various points of the service path.

In some embodiments, dataplane performance monitor of a beginning service node (or a proxy of the beginning service node) can record a first timestamp information comprising a timestamp associated with a time at which the beginning service node or a proxy of the beginning service node in the service path processes the packet. The beginning service node can generate the NSH using the first timestamp information before passing the packet with the NSH to the next service node. A “current” service node receiving the packet having the NSH with the first timestamp information can measure the latency between the beginning service node and the current service node itself based on a “current” time when the “current” service node received the packet and the first timestamp information.

In some embodiments, dataplane performance monitor of a “current” service node (or a proxy of the current service node) can record a second timestamp information which is associated with a time at which the current service node processes the packet (e.g., associated with egress timing). Before or prior to forwarding the packet to the next service node in the service path, the second timestamp information can be added to the NSH (in some cases replacing timestamp information recorded at the previous service node). For instance, the next service node can use this second timestamp information to measure inter-hop latency.

Flow Identifier

Because many traffic flows can be using the same service path, the telemetry information can include a flow identifier (e.g., a Sub-Flow ID, a service flow identifier (SFID)) to identify individual flows (from the service classifier's perspective) in the service path. Using the flow identifier, network performance characteristics can be determined on a traffic flow by traffic flow basis (or some other classification for classifying different types of traffic). For instance, the flow identifier can be used to distinguish different classes of traffic (specific User Datagram Protocol (UDP) flow, or a differentiated services code point (DSCP) class). In these cases, the flow identifier can be set to a non-zero value from a set of possible values which uniquely identifies the different classes of traffic. In some cases, the flow identifier can include one or more suitable identifiers for uniquely identifying a portion of the traffic being transported over the service path.

Passive Versus Active Performance Monitoring

Many examples described herein refer to packets which carry user data, and the telemetry information carried in the NSH is part of a passive dataplane monitoring scheme. In other words, the telemetry information is piggybacked with normal/regular user traffic. It is also possible to use the improved NSH with synthetic traffic (i.e., traffic flows generated specifically for telemetry purposes or to probe the service nodes in the service path without carrying actual user data).

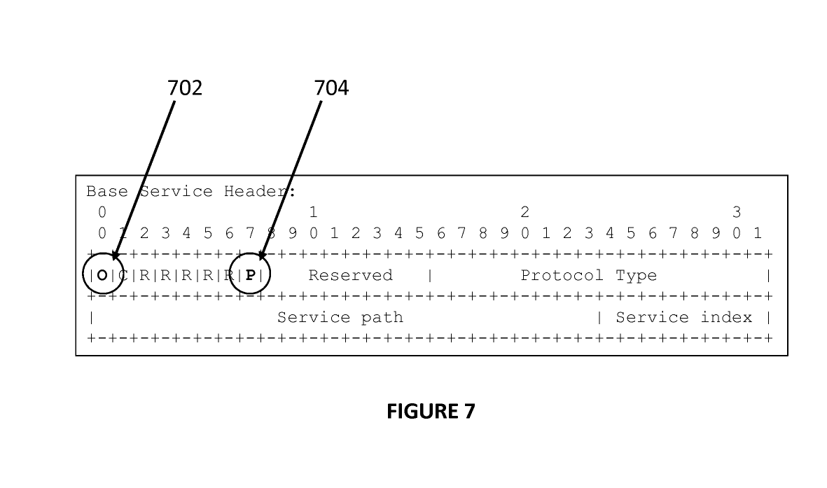

FIG. 7 shows an exemplary service header employing two flags, according to some embodiments of the disclosure. Further to a first flag 704 for indicating whether the NSH includes telemetry information, the NSH can include a second flag 702 for indicating whether the packet is part of a synthetic traffic flow or a user traffic flow. The first flag 704 for indicating whether the NSH includes telemetry information is referred herein as the “P-flag”; the second flag 702 and the second flag for indicating whether the packet is part of a synthetic traffic flow or a user traffic flow is referred herein as the “O-flag.” The second flag 702 being set to a particular state can indicate that the packet is an operations and management (OAM) packet. When the second flag 702 is set to the particular state, service nodes may examine the payload and/or take appropriate action upon receipt of the packet (e.g., return status information, review telemetry information in the NSH, etc.).

In some cases, the second flag 702 (or some other suitable field or flag in the network service header) being set to a particular state can trigger or indicate to a service node receiving such a packet to report information associated with the packet to another service node or a suitable monitoring node. For instance, dataplane performance monitor can transmit a third timestamp information to a monitoring node. The third timestamp information can be associated with a time at which the first service node processes the packet, and the third timestamp information is usable by the monitoring node in compiling a list of timestamps associated with times at which a plurality of service nodes of the service path processes the packet.

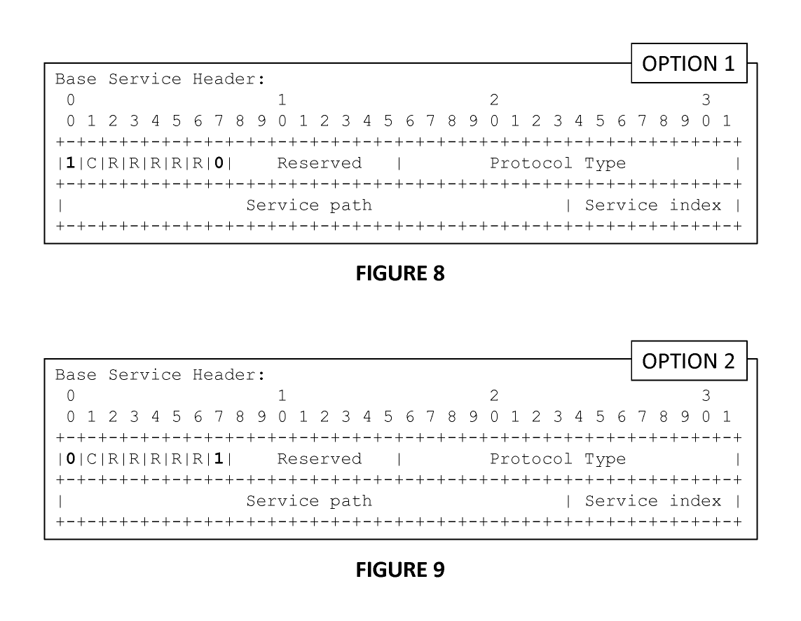

FIGS. 8-9 show two examples of the service header having the two flags set to indicate whether the network service header has fields carrying dataplane performance monitoring information and a type of traffic flow, according to some embodiments of the disclosure. In the exemplary option shown in FIG. 8, the two flags can be set where the O-flag is set to 1 and the P-flag is set to 0, to indicate that the packet is being used for passive monitoring (packet is part of synthetic traffic, and NSH of the packet has telemetry information). In a variation, the O-flag is set to 1 and the P-flag is set to 1 to (equivalently) indicate that the packet is being used for passive monitoring (packet is part of synthetic traffic, and NSH of the packet has telemetry information). In the exemplary option shown in FIG. 9, the two flags can be set where the O-flag is set to 0 and the P-flag is set to 1 to indicate that the packet is being used for active monitoring (packet is part of user traffic).

Within the life of a flow, a hybrid performance monitoring approach can be used. For instance, when there is user traffic on the Service Path, passive monitoring can be used, and when there is no user traffic on the Service Path, a service node of the Service Path or a monitoring node can inject synthetic traffic to allow for active performance monitoring. The hybrid mode is particularly advantageous because synthetic traffic can be seen as counterproductive or intrusive to the network, the ability to provide both active and passive monitoring thus reduces intrusion while being able to record and collect telemetry information consistently (i.e., more or less most of the time during the life of the flow).

Exemplary Performance Monitor Status

A service node or any suitable monitoring node can report service performance status information at the service level. An exemplary report is shown below:

DC#sh service performance monitor status sfid any
transport packets expected counter : 6206
transport packets lost counter : 8
transport packets lost rate ( % ) : 0.12
transport event packet-loss counter : 2
transport rtp jitter mean (usec) : 160
transport rtp jitter minimum (usec) : 0
transport rtp jitter maximum (usec) : 18676
counter bytes : 1239600
counter packets : 6198
counter bytes rate : 4132 service bytes
counter : 1066056
service bytes rate : 3553
service packets counter : 6198
service packets rate : 20
service event : Normal
service version : 9.1.1
service vendor : ABC, Inc.
service index : 5
service id : XYZ

Service Function Chain Proxy

In some cases, a network element providing service functions is not a SFC-aware network element. The network element may be is augmented with a SFC Proxy (a logical element in the network). The SFC Proxy can implement the service header processor 306 and dataplane performance monitor 310 (of FIG. 3) as described herein. For instance, SFC Proxy can remove and insert SFC encapsulation on behalf of a SFC-unaware service function. Once SFC encapsulation is removed, the Proxy can deliver the packet/frame, e.g., via a local attachment circuit (of a local area network or tunnel) to the SFC-unaware service function. When complete, the SFC-unaware service function returns the packet to the NSH-proxy via the same or different attachment circuit. NSH is applied to the packet returned to the proxy from the non-NSH aware service.

Variations and Implementations

Within the context of the disclosure, a network used herein represents a series of points, nodes, or network elements of interconnected communication paths for receiving and transmitting packets of information that propagate through a communication system. A network offers communicative interface between sources and/or hosts, and may be any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology. A network can comprise any number of hardware or software elements coupled to (and in communication with) each other through a communications medium. In one particular instance, the architecture of the present disclosure can be associated with a service provider deployment. In other examples, the architecture of the present disclosure would be equally applicable to other communication environments, such as an enterprise wide area network (WAN) deployment. The architecture of the present disclosure may include a configuration capable of transmission control protocol/internet protocol (TCP/IP) communications for the transmission and/or reception of packets in a network.

As used herein in this Specification, the term ‘network element’ is meant to encompass any of the aforementioned elements, as well as servers (physical or virtually implemented on physical hardware), machines (physical or virtually implemented on physical hardware), end user devices, routers, switches, cable boxes, gateways, bridges, loadbalancers, firewalls, service nodes, monitoring nodes, proxies, processors, modules, or any other suitable device, component, element, proprietary appliance, or object operable to exchange, receive, and transmit information in a network environment. Generally speaking, the network element performing the functions related to the dataplane performance monitoring are the network elements which are service chain aware, e.g., service nodes, monitoring nodes, etc. These network elements may include any suitable hardware, software, components, modules, interfaces, or objects that facilitate the dataplane performance monitoring operations thereof. This may be inclusive of appropriate algorithms and communication protocols that allow for the effective exchange of data or information.

In one implementation, the network elements such as service nodes and monitoring nodes described herein may include software to achieve (or to foster) the functions discussed herein for dataplane performance monitoring where the software is executed on one or more processors to carry out the functions. This could include the implementation of instances of service header processor and dataplane performance monitor and/or any other suitable element that would foster the activities discussed herein. Additionally, each of these elements can have an internal structure (e.g., a processor, a memory element, etc.) to facilitate some of the operations described herein. In other embodiments, these functions for dataplane performance monitoring may be executed externally to these elements, or included in some other network element to achieve the intended functionality. Alternatively, network elements, such as the service nodes and monitoring nodes, may include software (or reciprocating software) that can coordinate with other network elements in order to achieve the dataplane performance monitoring functions described herein. In still other embodiments, one or several devices may include any suitable algorithms, hardware, software, components, modules, interfaces, or objects that facilitate the operations thereof.

In certain example implementations, the dataplane performance monitoring functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification. The memory element is further configured to store databases such as databases for storing information in the network service headers and/or information logged by the service node or monitoring node. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving dataplane performance monitoring, as outlined herein. Additionally, each of these devices may include a processor that can execute software or an algorithm to perform the dataplane performance monitoring as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the systems described herein are readily scalable and, further, can accommodate a large number of components, as well as more complicated/sophisticated arrangements and configurations. Accordingly, the examples provided should not limit the scope or inhibit the broad techniques of dataplane performance monitoring, as potentially applied to a myriad of other architectures.

It is also important to note that the steps (e.g., described in relation the FIG. 4) illustrate only some of the possible scenarios that may be executed by, or within, the network elements described herein. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by network elements in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for monitoring performance of a service path identified by a service path identifier, the service path connecting a first end point and a second end point via one or more service nodes, the method comprising:
receiving, at a first service node, a packet of a flow being transported over the service path; and
processing, at the first service node, a network service header of the packet, wherein the network service header comprises the service path identifier and one or more of the following:
(1) sequence number;
(2) a first timestamp information, and
(3) flow identifier associated with the flow being transported over the service path.

2. The method of claim 1, further comprising:
determining one or more network performance characteristics of the flow based on any one or more of (1), (2), and (3).

3. The method of claim 2, wherein the one or more network performance characteristics includes one or more of the following: packet count, packet delay, jitter, packet loss, network latency, reordered packet count, duplicate packet count, service throughput, and inter-service node latency.

4. The method of claim 1, wherein:
processing the network service header of the packet comprises storing information from the network service header in a memory.

5. The method of claim 1, wherein the first timestamp information comprises a timestamp associated with a time at which a beginning service node or a proxy of the beginning service node in the service path processes the packet.

6. The method of claim 1, further comprising:
adding, at the first service node, a second timestamp information to the network service header prior to forwarding the packet to a second service node in the service path, wherein the second timestamp information is associated with a time at which the first service node processes the packet.

7. The method of claim 1, wherein the network service header further comprises a first flag for indicating that the network service header carries one or more of (1) to (3).

8. The method of claim 1, wherein the network service header further comprises a second flag for indicating the packet is part of a synthetic traffic flow or a user traffic flow.

9. The method of claim 1, further comprising:
transmitting, by the first service node, a third timestamp information to a monitoring node, wherein the third timestamp information is associated with a time at which the first service node processes the packet, and the third timestamp information is usable by the monitoring node in compiling a list of timestamps associated with times at which a plurality of service nodes of the service path processes the packet.

10. An apparatus for monitoring performance of a service path identified by a service path identifier, the service path connecting a first end point and a second end point via one or more service nodes, comprising:
at least one memory element;
at least one processor coupled to the at least one memory element; and
a service header processor that when executed by the at least one processor is configured to:
receive, at a first service node, a packet of a flow being transported over the service path; and
process, at the first service node, a network service header of the packet, wherein the network service header comprises the service path identifier and one or more of the following:
(1) sequence number;
(2) a first timestamp information, and
(3) flow identifier associated with the flow being transported over the service path.

11. The apparatus of claim 10, further comprising:
a dataplane performance monitor that when executed by the at least one processor is configured to determine one or more network performance characteristics of the flow based on any one or more of (1), (2), and (3).

12. The apparatus of claim 11, wherein the one or more network performance characteristics includes one or more of the following: packet count, packet delay, jitter, packet loss, network latency, reordered packet count, duplicate packet count, service throughput, and inter-service node latency.

13. The apparatus of claim 10, wherein:
processing the network service header of the packet comprises storing information from the network service header in the at least one memory element.

14. A computer-readable non-transitory medium comprising one or more instructions, for monitoring performance of a service path identified by a service path identifier, the service path connecting a first end point and a second end point via one or more service nodes, that when executed on a processor configure the processor to perform one or more operations comprising:
receiving, at a first service node, a packet of a flow being transported over the service path; and
processing, at the first service node, a network service header of the packet, wherein the network service header comprises the service path identifier and one or more of the following:
(1) sequence number;
(2) a first timestamp information, and
(3) flow identifier associated with the flow being transported over the service path.

15. The computer-readable non-transitory medium of claim 14, wherein the operations further comprises:
determining one or more network performance characteristics of the flow based on any one or more of (1), (2), and (3).

16. The computer-readable non-transitory medium of claim 14, wherein the first timestamp information comprises a timestamp associated with a time at which a beginning service node or a proxy of the beginning service node in the service path processes the packet.

17. The computer-readable non-transitory medium of claim 14, wherein the operations further comprises:
adding, at the first service node, a second timestamp information to the network service header prior to forwarding the packet to a second service node in the service path, wherein the second timestamp information is associated with a time at which the first service node processes the packet.

18. The computer-readable non-transitory medium of claim 14, wherein the network service header further comprises a first flag for indicating that the network service header carries one or more of (1) to (3).

19. The computer-readable non-transitory medium of claim 14, wherein the network service header further comprises a second flag for indicating the packet is part of a synthetic traffic flow or a user traffic flow.

20. The computer-readable non-transitory medium of claim 14, wherein the operations further comprises:
transmitting, by the first service node, a third timestamp information to a monitoring node, wherein the third timestamp information is associated with a time at which the first service node processes the packet, and the third timestamp information is usable by the monitoring node in compiling a list of timestamps associated with times at which a plurality of service nodes of the service path processes the packet.
